(19) United States
(12) Patent Application Publication
(10) Pub. No.: US 2026/0315971 A1
(43) Pub. Date: Oct. 15, 2026

(54) NANOCOMPOSITE SCAFFOLDS CONTAINING CELLULOSE SUBSTRATE AND METAL OXIDE NANOCRYSTALS AS ADSORBENTS FOR REMOVAL OF TOXIC IMPURITIES

(71) Applicant: The Research Foundation for The State University of New York, Albany, NY (US)

(72) Inventors: Benjamin S. Hsiao, Setauket, NY (US); Sunil Kumar Sharma, Kalamazoo, MI (US); Priyanka R. Sharma, Kalamazoo, MI (US)

(21) Appl. No.: 18/880,950

(22) PCT Filed: Jul. 17, 2023
(86) PCT No.: PCT/US2023/070332

§ 371 Date: Jan. 3, 2025

Related U.S. Application Data
(60) Provisional application No. 63/368,671, filed on Jul. 18, 2022.

(51) Int. Cl. B01D 39/18

(52) U.S. Cl. CPC B01D 39/18; B01D 2239/025; B01D 2239/0258; B01D 2239/0407; B01D 2239/10; B01D 2239/1225; B01D 2239/1233

(57) ABSTRACT

The present disclosure provides a nanocomposite scaffold suitable for treating water to remove impurities therefrom. The nanocomposite scaffold includes a cellulose substrate possessing metal oxide nanocrystals. Methods for preparing the nanocomposite scaffold and using the nanocomposite scaffold to purify water are also provided.

### CROSS REFERENCE TO RELATED APPLICATIONS

This application claims the benefit of, and priority to, U.S. Provisional Patent Application Ser. No. 63/368,671, filed Jul. 18, 2022, the entire disclosure of which is incorporated by reference herein.

### GOVERNMENT SUPPORT STATEMENT

This invention was made with government support under DMR-1808690 awarded by the National Science Foundation. The government has certain rights in the invention.

### BACKGROUND

Separation processes are important in many industries. Membrane separation technology has been widely adapted in many separation processes due to its broad range of advantages, including lower energy and chemical consumption, and easier operation and maintenance. These processes include water purification, desalination, air filtration/separation, etc.

Membranes used for filtration should have certain desirable properties. For example, a greater volume of material to be filtered, sometimes referred to as throughput, is one desirable property. The ability to remove contaminants, sometimes referred to as selectivity, is another desirable property. Reducing the clogging of the membranes, so that the fouling of the membranes is low and requires less frequent cleaning and/or the use of harsh chemicals or processes for cleaning, is yet another desirable property.

Improved membranes and methods for forming membranes, as well as uses thereof, remain desirable.

### SUMMARY

The present disclosure provides novel cellulose membranes, sometimes referred to herein as a nanocomposite scaffold, and methods for making same. In embodiments, a nanocomposite scaffold of the present disclosure includes a cellulose substrate and metal oxide nanocrystals.

In embodiments, a nanocomposite scaffold of the present disclosure includes a cellulose substrate; and metal oxide nanocrystals selected from zinc oxide, iron(II) oxide, iron(III) oxide, titanium dioxide, aluminium oxide, copper(II) oxide, copper(I) oxide, calcium oxide, lithium oxide, silver oxide, manganese dioxide, manganese(II) oxide, sodium oxide, magnesium oxide, chromium(VI) oxide, or combinations thereof, wherein the metal oxide nanocrystals are present in an amount from about 20% by weight of the nanocomposite scaffold to about 50% by weight of the nanocomposite scaffold.

In some embodiments, the metal oxide nanocrystals are present in an amount from about 30% by weight of the nanocomposite scaffold to about 45% by weight of the nanocomposite scaffold.

In embodiments, the cellulose substrate is formed of regenerated microfibrillated cellulose, nanofibrillated cellulose, cellulose nanocrystals, cellulose nanofibers, or combinations thereof.

In other embodiments, the cellulose substrate is formed of regenerated microfibrillated cellulose fibers having a length from about 200 nm to about 300 nm and a diameter from about 100 nm to about 200 nm.

In some embodiments, the cellulose substrate is formed of regenerated microfibrillated cellulose fibers having a length from about 225 nm to about 275 nm and a diameter from about 125 nm to about 175 nm.

In embodiments, the regenerated microfibrillated cellulose includes a cellulose II polymorph.

In some embodiments, the metal oxide nanocrystals include zinc oxide.

In embodiments, a method of the present disclosure includes contacting cellulose fibers with an acid selected from phosphoric acid, sulfuric acid, hydrochloric acid nitric acid, or combinations thereof, the acid at a concentration from about 70% by weight to about 90% by weight, for a period of time from about 2.5 minutes to about 7.5 minutes, to form a suspension, and heating the suspension to a temperature from about 65° C. to about 75° C., for a period of time from about 25 minutes to about 35 minutes, to form a solution. The solution is then contacted with ethanol, butyl carbitol, butyl cellusolve, diethylene glycol monobutyl ethers, or diethylene glycol monoethyl ethers. The method includes then cooling the solution, removing the supernatant; and collecting regenerated microfibrillated cellulose fibers.

In some embodiments, the cellulose fibers are jute fibers having a moisture content from about 17.5% by weight to about 27.5% by weight.

In embodiments, contacting the cellulose fibers with the acid occurs by contacting the cellulose fibers with the acid at a concentration from about 80% by weight to about 87.5% by weight.

In some embodiments, contacting the cellulose fibers with the acid occurs at a temperature from about 65° C. to about 90° C., for a period of time from about 25 minutes to about 35 minutes.

In embodiments, the method further includes contacting the regenerated microfibrillated cellulose fibers with metal oxide nanocrystals selected from zinc oxide, iron(II) oxide, iron(III) oxide, titanium dioxide, aluminium oxide, copper(II) oxide (CuO), copper(I) oxide, calcium oxide, lithium oxide, silver oxide, manganese dioxide, manganese(II) oxide, sodium oxide, magnesium oxide, chromium(VI) oxide, or combinations thereof, to form a nanocomposite scaffold including a cellulose substrate and the metal oxide nanocrystals.

In some embodiments, the method further includes contacting a solution possessing metal oxide nanocrystals or precursors thereof with a first suspension including the regenerated microfibrillated cellulose fibers, to form a nanocomposite scaffold including a cellulose substrate and the metal oxide nanocrystals.

In embodiments, the metal oxide nanocrystals utilized in the method are selected from zinc oxide, iron(II) oxide, iron(III) oxide, titanium dioxide, aluminium oxide, copper(II) oxide, copper(I) oxide, calcium oxide, lithium oxide, silver oxide, manganese dioxide, manganese(II) oxide, sodium oxide, magnesium oxide, chromium(VI) oxide, or combinations thereof.

In embodiments, the solution possessing metal oxide nanocrystals and the first suspension including the regenerated microfibrillated cellulose fibers are combined to form a second suspension.

In some embodiments, the second suspension is heated to a temperature from about 70° C. to about 90° C. and adjusted to a pH value of from about 8 to about 12.

In other embodiments, the method includes heating the second suspension for a period of time from about 1 hour to about 3 hours.

In embodiments, the method includes removing the supernatant from the second suspension to obtain a nanofibrous composite scaffold formed of a cellulose substrate and metal oxide nanocrystals.

In some embodiments, the method includes drying the nanocomposite scaffold at a temperature from about 95° C. to about 105° C.

In embodiments, methods for purifying water are provided, which include contacting the water with the nanocomposite scaffold of the present disclosure.

### BRIEF DESCRIPTION OF THE DRAWINGS

Various embodiments of the presently disclosed nanocomposite scaffolds and methods are described herein with reference to the drawings wherein:

FIG. 1 includes (i) FTIR spectra of jute cellulose, R-MFC and ZnO/R-MFC, and (ii) ¹³C CPMAS NMR spectra of jute cellulose and R-MFC.

FIG. 2 includes WAXD patterns of R-MFC and ZnO/R-MFC.

FIG. 3 includes (i) Zeta potential measurement of R-MFC (the average value=−8.58 mV), and (ii) BET measurement of R-MFC (surface area=10.74 m²/g).

FIG. 4 includes TEM images of (i) R-MFC and (ii) ZnO/R-MFC at low resolution, (iii) ZnO nanocrystals and (iv) ZnO nanocrystals when deposited on the R-MFC scaffold (a part of R-MFC highlighted by black circle) at high resolution, and (v) ED pattern of ZnO/R-MFC.

FIG. 5 includes graphs of (i) thermogravimetry profiles of (A) R-MFC and (B) ZnO/R-MFC, and (ii) Derivative thermogravimetry profiles of (A) R-MFC and (B) ZnO/R-MFC.

FIG. 6 includes graphs of (i) adsorption results fitted by the Langmuir isotherm model (Qe refers to the adsorption of metal ions, measured in milligrams of As(V) per gram of ZnO/R-MFC, Ce refers to the As(V) concentration), and (ii) the pH effect on As(V) adsorption.

FIG. 7 includes (i) a SEM image of ZnO/R-MFC coated with an As(V) deposit (15 ppm), and (ii) a SEM image of ZnO/R-MFC coated with an As(V) deposit (100 ppm).

FIG. 8 is a graph summarizing the results of a study of ZnO released from ZnO/R-MFC (i) at different pH values, and (ii) in the presence of different As(V) concentrations in the system. Experiments were performed at room temperature for 24 hours under occasional stirring.

### DETAILED DESCRIPTION

The following detailed description of embodiments of the subject matter of the present disclosure will be made in reference to the accompanying drawings. In describing the disclosure, explanation about related functions or constructions known in the art are omitted for the sake of clearness in understanding the concept of the present disclosure to avoid obscuring the recited subject matter with unnecessary detail.

The present disclosure provides a nanocomposite scaffold and method of manufacturing same. Embodiments of the present disclosure provide organic-inorganic composite scaffolds, including a negatively charged cellulose substrate, such as regenerated microfibrillated cellulose (R-MFC), nanofibrillated cellulose, cellulose nanocrystals (CNC), and/or cellulose nanofibers (CNF). The cellulose substrate has a high loading of metal oxide nanocrystals, such as zinc oxide (ZnO), iron(II) oxide (FeO), iron(III) oxide (Fe₂O₃), titanium dioxide (TiO₂), aluminium oxide (Al₂O₃), copper(II) oxide (CuO), copper(I) oxide (Cu₂O), calcium oxide (CaO), lithium oxide (Li₂O), silver oxide (Ag₂O), manganese dioxide (MnO₂), manganese(II) oxide (MnO), sodium oxide (Na₂O), magnesium oxide (MgO), chromium(VI) oxide (CrO₃), or combinations thereof, where the metal nanocrystals are strongly anchored to the cellulose substrate surface.

In embodiments, any suitable cellulosic material may be used to form the substrate of the nanocomposite scaffold of the present disclosure. The cellulose substrate can include partially or fully disintegrated cellulose fibers, having crystal structure of Cellulose I or Cellulose II. Any suitable method for producing the cellulose substrate and/or the materials used to form same may be employed. For example, the preparation of the cellulose substrate may occur by chemical treatment (regeneration/precipitation), sulfonation, oxidation, combined chemical/mechanical treatment (homogenization, microfluidization), combinations thereof, and the like.

The cellulose I polymorph in native cellulose is a stable crystalline structure due to the presence of immense intra-molecular and inter-molecular hydrogen bonding network. This structure is typically observed in higher plants, certain species of marine animals, bacteria, algae and fungi. The cellulose I polymorph cannot be readily dissolved in common organic solvents.

On the other hand, the cellulose II polymorph is another commonly observed structure in cellulose materials. Typically, it can be produced by two dissolution methods followed by regeneration: (i) dissolution using specialty solvents, such as ionic liquids, NaOH/urea, and molten salt hydrates; or (ii) mercerization using concentrated alkali (17-20%) to dissolve cellulose. In dissolution, the hydrogen bonds in cellulose I polymorph undergo some dynamic changes, allowing the formation of cellulose II polymorph during the regeneration process.

Based on X-ray fiber analysis, the cellulose II polymorph includes a monoclinic unit cell structure, where the cellulose chains are aligned along the 2-fold screw axes of the cell. Both cellulose chains have extended conformation but with different arrangement of the hydroxylmethyl group at the C6 position. A neutron fiber diffraction study of cellulose II has provided the evidence of three center intra-molecular hydrogen bonds in both chains, where O3 acts as the donor and O5 and O6 act as the acceptors. However, the inter-molecular hydrogen bonds are observed between origin chains, including O2 as the donor and O6 as the acceptor; and between the center chains involving O6 as the donor and O2 as the acceptor. The combined results indicate that the cellulose II polymorph includes two antiparallel crystallographically independent chains, bounded by hydrogen bonds. In addition, the inter-planar spacing (d spacing) between the adjacent lattices in the cellulose II polymorph is higher than that in cellulose I. This implies that during the conversion of cellulose I to cellulose II, the cellulose chains undergo a swelling process. This process would result in lower crystallinity and higher absorbability of the cellulose II polymorph as compared to that of the cellulose I polymorph.

Generally, the fibrillation treatment of biomass having the cellulose I polymorph using strong acids, such as sulfuric acid or hydrochloric acid, can produce nanoscale and highly crystalline cellulose nanoparticles, such as cellulose nanocrystals (CNC) and nanocrystalline cellulose (NCC). These treatments do not alter the original crystal structure (cellulose I).

However, in some cases, such as the treatment of nitric acid, or nitric acid/phosphoric acid can produce nanoscale cellulose (nanocellulose) of lower crystallinity (still with cellulose I structure), such as nanofibers, nanofibrils, nano-fibrillated cellulose and spherical shape nanoparticles. Typically, a strong acid would remove the amorphous regions in the cellulose assembly, leaving behind the crystalline entity. However, the use of nitric acid and/or phosphoric acid seems to offer an additional effect. For example, nitric acid can act as an oxidizing agent and introduce carboxyl groups on the cellulose surface, thus facilitating the nano-fibrillation process due to surface charge. Moreover, phosphoric acid is a good gelling and emulsion stabilizer to treat native cellulose. The use of phosphoric acid can cause swelling and ultimately dissolution of cellulose chains. The different stages of swelling or dissolution of cellulose chains depends on the time and temperature of the reaction conditions, as well as the concentration of phosphoric acid. The dissolved cellulose solution can be used to regenerate cellulose fibers having the cellulose II polymorph.

Among the different forms of cellulose particles, micro-fibrillated cellulose (MFC) is at a cross-sectional scale that is larger than that of nanocellulose. MFC can be extracted by mechanical treatment of wood-based cellulose using homogenization, which was first demonstrated by Turbak et al. in 1983. Since then, MFC has gained popularity in industrial applications, as it can be used as reinforcing agent in fabricating nanocomposite, rheology modifier and emulsifier, due to its unique properties including high mechanical strength, gelation tendency and good dispersibility. According to the most recent TAPPI classification, micro-fibrillated cellulose (MFC) is designated to the cellulose particles having the length dimensions in the range of several hundred micrometers and width is less than 100 nm.

MFC can also be prepared by a dissolution and regeneration process, and hence be referred to as regenerated micro-fibrillated cellulose (R-MFC). Generally, MFC possesses the cellulose I polymorph and R-MFC has the cellulose II polymorph. Most of the studies using the dissolution/regeneration approach to produce R-MFC by phosphoric acid involved the use of microcrystalline cellulose (MCC) derived from wood based cellulose. MCC is a hydrolyzed form of cellulose, having disruptive hydrogen bonding and hence, more prone to solubilization. Usually, it is difficult to dissolve the native cellulose from wood-based biomass because of intense network of intra- and inter-hydrogen bonds among the anhydroglucose units in cellulose chains.

The conventional methods to fabricate MFC include mechanical treatment (using homogenization, ball milling, microfluidizer and etc.), enzymatic treatment and chemical treatment (carboxymethylation etc.), which often involve intense usage of chemicals and electrical energy. With these methods, the produced MFC includes the cellulose I polymorph, as the original crystal structure remains unchanged.

In accordance with the present disclosure, it was found that the dissolution of native cellulose extracted from jute fibers (non-wood based cellulose) using phosphoric acid and regeneration of dissolved cellulose chains could form micro-fibrillated cellulose. The direct dissolution of native cellulose (from jute fibers) to produce R-MFC using phosphoric acid has not previously been demonstrated. The resulting R-MFC produced in accordance with the present disclosure was found to possess the cellulose II polymorph, low crystallinity, and high adsorption property that can effectively anchor the growth of metal nanocrystals, in embodiments ZnO nanocrystals.

In some embodiments, as described in greater detail in the below Examples, regenerated microfibrillated cellulose (R-MFC) fibers may be used to form the cellulose substrate of a nanocomposite scaffold of the present disclosure. The R-MFC fibers may be prepared by a combined dissolution and regeneration approach using a phosphoric acid/ethanol treatment of jute cellulose. The prepared R-MFC fibers possess high surface area (10.74 m²/g), good aspect ratio (L/D=30), and excellent thermal stability (Tₘₐₓ=352° C.). In addition, the fibers exhibited 3.84 wt % of phosphate groups (PO₄²⁻), with a zeta potential of −8.4 mV, and low crystallinity index (CI) of 47.5%.

For example, in embodiments, jute cellulose fibers may be used to form a cellulose substrate. In embodiments, the moisture content of the fibers may be from about 17.5% by weight to about 27.5% by weight, in embodiments from about 20% by weight to about 25% by weight. The fibers may be combined with a suitable acid, for example phosphoric acid, sulfuric acid, hydrochloric acid, nitric acid, combinations thereof, and the like, at a suitable concentration, in embodiments from about 70% by weight to about 90% by weight, in embodiments from about 80% by weight to about 87.5% by weight, in embodiments about 85% by weight. The fibers may be soaked in the acid for a suitable period of time, in embodiments from about 2.5 minutes to about 7.5 minutes, in embodiments about 5 minutes, with slow stirring, at a temperature from about 20° C. to about 30° C., and the suspension may then be heated to a temperature of about 65° C. to about 90° C., in embodiments about 70° C. The reaction may be allowed to occur for about 25 minutes to about 35 minutes, in embodiments about 30 minutes under stirring.

After the reaction, the resulting cellulose solution may be used to regenerate MFC using an appropriate ratio of ethanol (or butyl carbitol, butyl cellusolve, diethylene glycol monobutyl ethers and/or diethylene glycol monoethyl ethers), in embodiments anhydrous denatured ethanol. The amount of anhydrous denatured ethanol may be from about 10 mL to about 1000 mL of anhydrous denatured ethanol per gram of fiber. The entire mixture may then be placed in a freezer to cool down and allow the fibers to form and settle.

After 1 hour of settling, the supernatant may be removed, and the fibers may be recovered by solvent exchange using water. The suspension may then be placed in a dialysis bag with periodic replacement of the water bath until the water in the bath equilibrated at a low conductivity of 5 μS.

Where the cellulose substrate is formed of microfibrillated cellulose fibers, the microfibrillated cellulose fibers can be of a length from about 200 nm to about 300 nm, in other embodiments from about 225 nm to about 275 nm, in other embodiments about 250 nm. The diameter of the microfibrillated cellulose fibers can be from about 100 nm to about 200 nm, in other embodiments from about 125 nm to about 175 nm, in other embodiments about 150 nm.

Where the cellulose substrate is formed of nanofibrillated cellulose fibers, such as CNC or CNF, the nanofibrillated cellulose fibers could be of a length from about 50 nm to about 150 nm, in embodiments from about 75 nm to about 125 nm, in embodiments about 100 nm. The diameter of the cellulose fibers can be from about 30 nm to about 70 nm, in other embodiments from about 40 nm to about 60 nm, in other embodiments about 50 nm.

As noted above, the scaffold of the present disclosure includes metal oxide nanocrystals, such as zinc oxide (ZnO), iron(II) oxide (FeO), iron(III) oxide (Fe₂O₃), titanium dioxide (TiO₂), aluminium oxide (Al₂O₃), copper(II) oxide (CuO), copper(I) oxide (Cu₂O), calcium oxide (CaO), lithium oxide (Li₂O), silver oxide (Ag₂O), manganese dioxide (MnO₂), manganese(II) oxide (MnO), sodium oxide (Na₂O), magnesium oxide (MgO), chromium(VI) oxide (CrO₃), or any combination thereof.

The metal oxide nanocrystals may be applied to the cellulose substrate by any means within the purview of one skilled in the art, including direct application by spraying or any other method encompassing contacting the cellulose substrate with the metal oxide nanocrystals. The metal oxide nanocrystals both adhere to the cellulose substrate and the metal oxide nanocrystals may continue to grow in size as additional metal oxide is applied to existing metal oxide nanocrystals already adhered to the cellulose substrate.

In some embodiments, solutions and/or suspensions possessing the cellulose fibers and the metal oxide nanocrystals, or precursors thereof, may be combined and any solvent/fluid removed, to form the nanocomposite scaffold of the present disclosure.

For example, in embodiments a metal acetate may be dispersed in a suitable solvent, in some cases water. For example, where it is desired to form zinc oxide on the cellulose substrate, hydrated zinc acetate may be dispersed in distilled water to create a solution. The metal acetate may be in solution in a suitable amount, in embodiments from about 5% by weight of the solution to about 20% by weight of the solution, in embodiments from about 7.5% by weight of the solution to about 15% by weight of the solution, in other embodiments about 10% by weight of the solution. A suspension of R-MFC at a suitable concentration, in embodiments from about 1.5% by weight to about 5% by weight, in embodiments about 2% by weight may then be combined with the metal acetate solution.

The resulting suspension may then be heated to a suitable temperature, in embodiments from about 70° C. to about 90° C., in embodiments from about 75° C. to about 85° C., in embodiments about 80° C., and adjusted to a pH value of from about 8 to about 12, in embodiments from about 9 to 11, in embodiments about 10, using a suitable base. For example, in some embodiments, the pH adjustment may occur using a 10 wt % sodium hydroxide solution (added drop wise).

The suspension may be maintained at the above temperature, i.e., from about 70° C. to about 90° C., in embodiments from about 75° C. to about 85° C., in embodiments about 80° C., under rigorous stirring for a suitable time, in embodiments from about 1 hour to about 3 hours, in embodiments from about 1.5 hours to about 2.5 hours, in embodiments about 2 hours.

The reacted suspension may then be cooled to room temperature. The supernatant may then be decanted off the suspension. The solid portion which remains may be centrifuged, in aspects multiple times, to collect the final product. The final suspension may then be allowed to dry at a suitable temperature in an oven, in embodiments at from about 95° C. to about 105° C., in embodiments about 100° C., to form a nanocomposite scaffold of the present disclosure including a cellulose substrate and metal oxide nanocrystals.

The adhesion of nanocrystals to the cellulose substrate is strong due to electrostatic interactions. The metal oxide nanocrystals may be present in the nanocomposite scaffold in an amount from about 20% by weight of the nanocomposite scaffold to about 50% by weight of the nanocomposite scaffold, in embodiments from about 30% by weight of the nanocomposite scaffold to about 45% by weight of the nanocomposite scaffold, in other embodiments about 40% by weight of the nanocomposite scaffold.

In some aspects, the R-MFC fibers used to form the cellulose substrate of the nanocomposite scaffold are a cellulose II polymorph, confirmed by ¹³C CPMAS NMR and WAXD measurements. The R-MFC fibers are effective to anchor the growth of ZnO nanocrystals thereon. As described in greater detail in the below Examples, WAXD and TEM examinations on the imbedded ZnO nanocrystals indicated that they possessed the hexagonal wurtzite crystal structure and could assemble into a flower-like morphology in the R-MFC scaffold. A R-MFC composite containing 41 wt % of ZnO nanocrystals was found to be very efficient to remove arsenic (As(V)) ions from water with the maximum capacity of 4,421 mg/g at neutral pH (=7), based on the Langmuir isotherm analysis.

The selection of jute as the biomass source can be viewed as a model biomass to many other underutilized non-wood based species, such as agriculture residuals (straw). The R-MFC and ZnO nanocrystals composite network (ZnO/R-MFC) produced in accordance with the present disclosure was used to remove arsenic ions (As(V)) from water. The unique feature observed for the nanocomposite scaffolds of the present disclosure, as it relates to As(V) removal, was that the secured anchoring of ZnO nanoparticles in the R-MFC scaffold would provide large positively charged ZnO surface that can electrostatically interact with the H₂AsO₄⁻ ions (As(V) in pH 4-7).

According to EPA standards for arsenic impurities (As(III) and As(V)) in drinking water, the allowed limit is only 10 ppb. Hence, there is a great need to provide low-cost, sustainable, renewable and biodegradable materials for remediation of arsenic impurities from contaminated water.

The utilization of ZnO-incorporated R-MFC scaffolds of the present disclosure for removal of arsenic impurities may offer another advantage over existing adsorbents. The nanocomposite network of the present disclosure should reduce the secondary contamination problem.

The binding stability between ZnO nanocrystals and R-MFC, described in greater detail in the Examples below, confirmed that the composite scaffold only had negligible release of ZnO at neutral pH, indicating the viability of this system for practical water purification applications.

The resulting organic-inorganic composite is an effective adsorbent for removal of contaminants containing negatively charged ions, including As(V), As(III), NO₃⁻, NO₂⁻ PO₄²⁻, SO₄²⁻ from water.

Embodiments of the present disclosure as described herein provide at least the following advantages:

### 1. Use of Sustainable and Cost-Effective Cellulose Fibrous Substrate

Cellulose in the form of microfibrillated cellulose, regenerated microfibrillated cellulose, cellulose nanofibers, cellulose nanocrystals, nanofibrillated cellulose are sustainable, renewable and biodegradable materials, which can serve as a good cellulose substrate (with negatively charged surface) to host the in-situ growth of metal oxide nanocrystals, such as ZnO, FeO and TiO₂. The adhesion of nanocrystals on the cellulose substrate is strong due to electrostatic interactions, and the loading of the metal oxide nanocrystals can be high (e.g. 40 wt %).
The resulting metal oxide nanocrystals-cellulose composite scaffolds are effective adsorbents for removal of negatively charged contaminants such as arsenic and other toxic impurities.
The cellulose substrate can include partially or fully disintegrated cellulose fibers, having crystal structure of Cellulose I or Cellulose II. The microfibrillated cellulose fibers could be of size (L=>250 nm, D=<150 nm), where the nanofibrillated cellulose fibers, such as CNC or CNF could be of the size of (L=>100 nm, D=<50 nm). Any untreated/treated wood-based and non-wood-based biomass can be used to generate cellulose substrate.
The cellulose substrate can be prepared by simple and affordable methods such as chemical treatment (regeneration/precipitation), sulfonation, oxidation, combined chemical/mechanical treatment (homogenization, microfluidization etc.).

### 2. Cellulose Fibrous Substrates in the Form of Regenerated Microfibrillated Cellulose, Nanofibrillated and Regenerated Micro and Nanofibrillated Cellulose are Effective Scaffolds for Anchoring of High Content of Metal Oxide Nanoparticles.

Regenerated microfibrillated, microfibrillated and nanofibrillated cellulose, cellulose nanocrystals, cellulose nanofibers, all with negatively charged surface are effective substrate to anchor and host the in-situ growth of metal oxide nanocrystals, such as ZnO, FeO, TiO₂, etc. These organic-inorganic scaffolds are effective adsorbents to remove negatively charged toxic impurities including As(V), As(III), NO₃⁻, NO₂⁻ PO₄²⁻, SO₄²⁻ etc. The Examples below demonstrate that 41% of ZnO nanocrystals could be grown in a regenerated microfibrillated cellulose substrate.
   3. Higher Efficiency than Existing Adsorbents
The Examples below, describing nanocomposite scaffolds of the present disclosure made of regenerated microfibrillated cellulose (R-MFC) and ZnO nanocrystals, demonstrated the maximum removal capacity of 4,421 mg/g at neutral pH (=7) against As(V) impurities, based on the Langmuir isotherm analysis. This adsorption capacity is far higher than any existing inorganic and organic adsorbents such as zirconium oxide nanoparticles, titanium dioxide nanoparticles, yttrium nanoparticles, iron and carbon nanotubes composites.

### 4. Non-Toxic Substrate

The cellulose substrate, in the form of regenerated microfibrillated cellulose, nanofibrillated and regenerated micro and nanofibrillated cellulose, is biodegradable, abundant, sustainable, and biocompatible because it is extracted from untreated/raw/waste plant biomass.

### 5. Multiple-Usage of the Purifying Agent

The disclosed organic-inorganic nanocomposite scaffolds, containing a cellulose substrate in the form of regenerated microfibrillated cellulose, nanofibrillated and regenerated micro and nanofibrillated cellulose, loaded with appropriate metal oxide nanocrystals, can be used as a flocculant/coagulant/filter/membrane/beads to remove arsenic and other toxic impurities from water. These nanocomposite scaffolds can also be utilized to construct filters with adsorbent property.

### 6. Expeditious Adsorption Process

The remediation process using regenerated microfibrillated cellulose, nanofibrillated and regenerated micro and nanofibrillated cellulose loaded with appropriate metal oxide nanocrystals is fast, where the entire adsorption process can completed within 5 minute.

### 7. No Secondary Contamination

The high binding ability of regenerated microfibrillated cellulose, nanofibrillated and regenerated micro and nanofibrillated cellulose having negatively charged surface with positively charged metal oxide nanocrystals cause no risk of secondary contaminations.
The binding stability study between ZnO nanocrystals and regenerated microfibrillated cellulose confirmed that the composite scaffold only had negligible release of ZnO at neutral pH, indicating the viability of this system for practical water purification applications.

### 8. Recycling

The disclosed nanocomposite scaffolds, formed of regenerated microfibrillated cellulose, nanofibrillated and regenerated micro and nanofibrillated cellulose possessing metal oxide nanocrystals, are easily precipitated once in contact with impurities and hence much easier to separate out for recycling.

Several embodiments of the disclosure are described below with reference to the following non-limiting Examples. The Examples are intended to be illustrative only and are not intended to limit the scope of the present disclosure. As used herein, “room temperature” refers to a temperature of from about 20° C. to about 30° C. Also, parts and percentages, such as solution percentages, are by weight unless otherwise indicated.

### EXAMPLES

### Materials

Phosphoric acid (≥85 wt %) ACS Reagent was obtained from Sigma-Aldrich. Anhydrous denatured ethanol and sodium hydroxide (pellets) were purchased from VWR Amresco Life Sciences. All chemicals were used without any further purification. Raw jute fibers (DP of extracted cellulose=516) were procured from Toptrans Bangladesh Ltd. in Bangladesh. Sodium arsenate dibasic heptahydrate as a source of As(V) was also purchased from Sigma Aldrich.

### Example 1

Extraction of Cellulose from Jute fibers. Raw jute fibers contain three major components of biomass: cellulose, hemicellulose and lignin, where only the cellulose portion from jute was extracted for this study using the following procedure. The jute fiber samples were cut into small pieces with lengths between 2 to 5 cm. The chopped fibers were first pretreated by soaking in sodium hydroxide solution (2 wt %) at 80° C. for 6 hours. The fibers were then washed with distilled water several times until the pH value of the filtrate became neutral. The resulting fibers were then dried in oven at 60° C. for 24 hours.

Pretreated fibers were subsequently bleached using a sodium chlorite solution (1 wt %) adjusted to pH=4 with acetic acid. The fibers were soaked in the above solution and heated at 70° C. for 3 hours. After 3 hours, the fibers were removed from the solution by using microfiltration and re-dispersed in sodium chlorite solution (1 wt %) at pH=4. This step was repeated five times followed by washing of the treated fibers several times with distilled water until the filtrate became neutral. The resulting cellulose fibers were soft and had a bright white color.

### Example 2

Preparation of Regenerated Micro-fibrillated Cellulose (R-MFC). Extracted jute cellulose (1 gram, moisture content=20-25%) prepared in Example 1 above was added to a round bottom flask containing 15 mL of phosphoric acid (85 wt %), which was preheated in an oil bath at 70° C. The fibers were first soaked into the acid for 5 minutes under slow stirring, and the suspension was raised to 70° C. to carry out the reaction for 30 minutes under more rigorous stirring. After the reaction, a transparent cellulose solution was observed, which was used to regenerate MFC using the appropriate ratio of anhydrous denatured ethanol (100 mL of anhydrous denatured ethanol per gram of fiber). The entire mixture was then placed in a freezer to cool down and allow the fibers to form and settle.

After 1 hour of settling, the supernatant was removed, and the fibers were recovered by solvent exchange using water. The suspension was then placed in a dialysis bag with periodic replacement of the water bath until the water in the bath equilibrated at a low conductivity of 5 μS.

### Example 3

Degree of Phosphorylation of R-MFC. The degree of phosphorylation of the R-MFC produced in Example 2 was determined as follows. About 39 mg of dried R-MFC was dispersed in 10 mL of sulfuric acid (98%) and the mixture was distilled at 90° C. for 24 hours. The treatment caused the removal of phosphate (PO₄²⁻) groups from cellulose chains in the form of phosphoric acid through hydrolysis. The mixture was then cooled to room temperature and was filtered using vacuum filtration. The filtrate obtained was 6.5 mL and was diluted back to 10 mL.

The concentration of PO₄²⁻ in the solution (filtrate) was analyzed using an inductively coupled plasma mass spectrometry (ICP-MS) instrument. The residue from the filtration was again treated using sulfuric acid in order to confirm the complete elimination of the PO₄²⁻ group in the form of phosphoric acid from R-MFC. The resulting filtrate was characterized again using ICP-MS. The degree of substitution of the phosphate group on cellulose was calculated from the mass elimination of phosphate containing cellulose and the weight of cellulose used in the experiment.

### Example 4

Preparation of ZnO Nanocrystals Incorporated in Regenerated Micro-Fibrillated Cellulose (ZnO/R-MFC). To prepare the ZnO/R-MFC scaffold, the following procedures were implemented. Hydrated zinc acetate was first dispersed in 25 mL of distilled water to create a 10 wt % solution. 50 mL of a 2 wt % R-MFC suspension produced in accordance with Example 2 above was then added to a beaker under gentle stirring. The suspension was heated to 80° C. and adjusted to the pH value of 10 using a 10 wt % sodium hydroxide solution (added drop wise). The resulting suspension became opaque (milky white) after the complete addition of sodium hydroxide.

The beaker was then heated to 80° C. and maintained at that temperature under rigorous stirring for 2 hours. The reacted suspension was subsequently removed from the heating mantle and cooled to room temperature. Upon the settling of the opaque white layer, the upper portion (supernatant) was carefully decanted off the suspension. The solid white portion was centrifuged three times at 5000 g (relative centrifugal force) each for 10 minutes to collect the final product. The final suspension was then spread on a glass dish and allowed to dry at 100° C. in the oven.

### Example 5

Attenuated Total Reflection Fourier Transform Infrared (ATR-FTIR) Spectroscopy of bleached jute cellulose, R-MFC and ZnO/R-MFC. ATR-FTIR was performed using a PerkinElmer Spectrum One instrument, equipped with a single-reflection accessory unit having a diamond ATR crystal. The ATR spectra were recorded in the transmission mode, between 450 and 4000 cm⁻¹ at room temperature. A total of 6 scans were taken per sample with a resolution of 4 cm⁻¹.

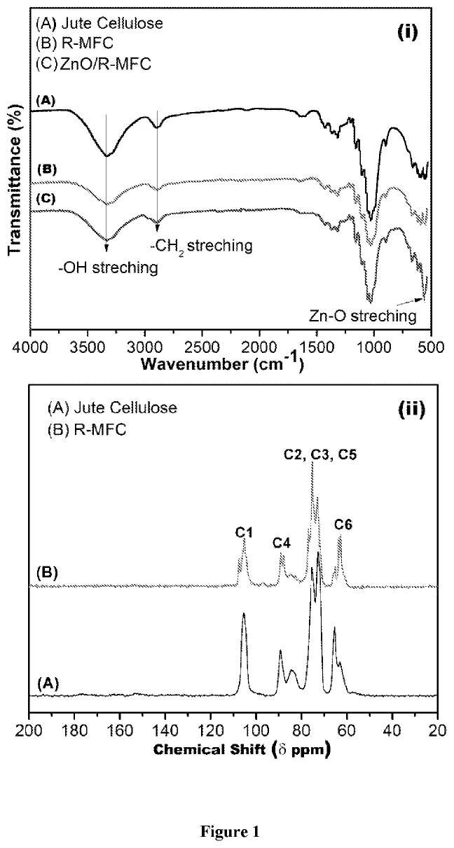

FIG. 1(i) shows the FTIR spectra of bleached jute cellulose, R-MFC and ZnO/R-MFC. All three spectra exhibited the characteristic peaks of cellulose at 3340 cm⁻¹, which could be attributed to the O—H stretching vibrations, a peak at 2900 cm⁻¹ due to the CH and CH₂ stretching, and bands at 1372, 1150, 1100, and 1030 cm⁻¹ due to the C—O—C stretching in glycosidic bonds. These results indicate that the cellulose structure was maintained in R-MFC, as expected. The cellulose characteristic peaks (3340, 2900, 1165 and 1120 cm⁻¹) also remained in the ZnO/R-MFC composite, indicating that there was no chemical bonding occurred between R-MFC and ZnO nanocrystals. In the ZnO/R-MFC sample, the appearance of 533 cm⁻¹ due to the Zn—O stretching confirmed the presence of ZnO nanocrystals.

### Example 6

¹³C Cross-Polarization Magic Angle Spinning Nuclear Magnetic Resonance Spectroscopy (¹³C CPMAS NMR) of jute and R-MFC. All dried samples were packed uniformly in a zirconium oxide rotor. The ¹³C CPMAS NMR spectra were carried out by a Bruker Utrashield 500WB plus (500 MHz) NMR instrument, equipped with a 2.5 mm triple resonance magic angle spinning (MAS) NMR probe, capable of spinning samples up to 35 KHz. The resonance frequency for ¹³C was 10,000 Hz and the samples were spun at the magic angle with a speed of 10 KHz.

Solid state ¹³C CPMAS NMR spectra of jute cellulose and R-MFC are illustrated in FIG. 1(ii). In the jute cellulose spectrum, the corresponding cellulose chains peaks were seen: 105 ppm due to C1 carbons, 89.13 ppm (doublet) due to both crystalline and amorphous regions of C4 carbons, and doublet at 65.45 ppm (larger peak) and 62.5 ppm (smaller peak) due to both crystalline and amorphous regions of C6 carbons in the cellulose chains. The highest intensity between 72.3-75.3 ppm could be contributed to C2, C3 and C5 carbons. All these peaks were in good agreement with the cellulose I polymorph. However, the ¹³C CPMAS NMR spectrum of R-MFC (FIG. 1(ii) B) showed some small changes when compared with the peak positions of jute cellulose.

For example, in R-MFC, the C1 signal bifurcated into 107 and 105 ppm peaks (the original C1 position was at 105 ppm in jute). In addition, the C4 peak appeared as triplet, having a new small peak appearing at 83.79 μm as compared with original C4 doublet in jute. Similarly, the initial doublet peaks from the cluster of C2, C3 and C5 carbons in R-MFC became triplet peaks at 77.3, 75.0, 73.0 ppm. Interestingly, the intensity of the C6 doublet peaks in R-MFC at 65.45 ppm was low (small) and 62.7 ppm was high (large), whereas they were opposite to those of the initial C6 doublet in jute cellulose.

The changes in the intensity and position of the ¹³C CPMAS NMR spectrum in R-MFC when compared with those of jute cellulose suggested the conversion of cellulose I to cellulose II polymorph. The resonance assignment for the ¹³C CPMAS NMR spectra of jute cellulose and R-MFC are summarized in Table 1 below.

TABLE 1
The resonance assignment for the ¹³C CPMAS
NMR spectra of jute cellulose and R-MFC.

| | C1 | C4 | C2, C3, C5 | C6 |
|---|---|---|---|---|
| | (ppm) | (ppm) | (ppm) | (ppm) |
| Jute Cellulose | 105 | 89.13 | 75.37 | 65.45 (large) |
| | | | 72.33 | 62.5 (small) |
| R-MFC | 107 | 89.6, 87.6 | 77.3 | 65.45 (small) |
| | 105 | 83.7 | 75.0 | 62.7 (large) |
| | | | 73.0 | |

It has been documented that the cellulose I polymorph can be transformed into cellulose II polymorph when the cellulose chains undergo mercerization (swelling in 17-20% sodium hydroxide) and regeneration/precipitation processes. This was also the case of using phosphoric acid to prepare regenerated micro-fibrillated cellulose.

### Example 7

Wide-Angle X-ray Diffraction (WAXD). X-ray diffraction measurements of R-MFC and ZnO/R-MFC were carried out using a Benchtop Rigaku MiniFlex 600 instrument. The samples were coated on the glass sample holders. The Cu Kα radiation was generated at 40 kV and 40 mA (λ=0.154 nm) using a Ni filter. Data collection was carried out using a flat holder in the Bragg-Brentano geometry (5-50°; 10° C. min-1).

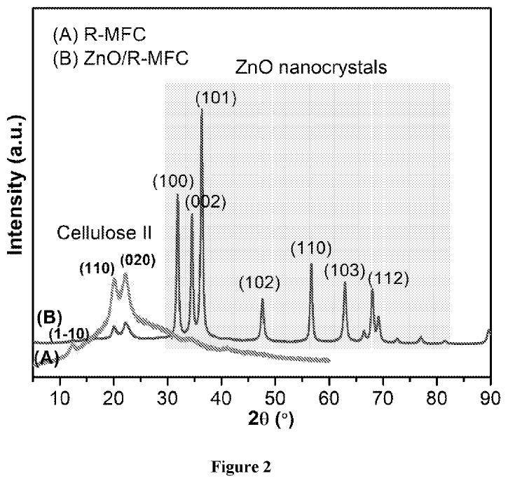

WAXD patterns of R-MFC and ZnO/R-MFC are illustrated in FIG. 2. The WAXD patterns of R-MFC (FIG. 2A) exhibited the characteristic peaks of the cellulose II structure, where the peaks positioned at 2θ angles of 12.07°, 19.97°, 22.2° corresponded to the (1-10), (110), and (002) planes. The crystallinity index of R-MFC prepared by the phosphoric acid treatment was about 47.5%, which was significantly lower than the initial crystallinity of jute cellulose fibers (~80%).

The WAXD patterns of ZnO/R-MFC showed distinct diffraction peaks from both cellulose II structure and ZnO crystals, comprising of 19.97° and 22.2°, corresponding to the (110) and (020) planes from the cellulose II structure, respectively, and the diffraction peaks due to the diffraction from the (100), (002), (101), (102), (110), (103), (112) planes of the hexagonal wurtzite crystal structure of ZnO.

The WAXD diffraction peaks from cellulose II (FIG. 2(A)) were found to be much weaker than those from ZnO nanocrystals. The results clearly indicated that R-MFC served as an effective scaffold to host the formation of ZnO nanocrystals.

Recently, it has been reported that ZnO nanocrystals grown in the form of flower-like morphology have exhibited enhanced toxicological effect in cancer cells. As no changes were found in the ATR-FTIR spectrum or the WAXD patterns of R-MFC in the presence of ZnO nanocrystals, this indicated the absence of direct chemical bonding between ZnO and R-MFC. It is believed the main cause of the binding between ZnO nanoparticles and cellulose nanofibers is electrostatic attraction. The presence of electrostatic interactions between ZnO nanocrystals and R-MFC was further confirmed by the stability study of ZnO/R-MFC composite in aqueous media.

### Example 8

Zeta Potential Measurements. A Zetaprobe Analyzer™ (Colloid Dynamics), equipped with built-in titration set up, pH electrode and ESA sensor probe, was used to measure the zeta potential of R-MFC sample. Before analyzing the sample, the pH electrode was calibrated using 3 different pH buffer standards (pH=4.01, 7.01 and 10.01), followed by a standard titration solution. The ESA sensor was calibrated using the standard zeta probe polar solution (KSiW solution). Upon the completion of calibration test, the R-MFC suspension (0.2 wt %, 250 mL) was filled in the sample holder, where the ESA sensor was then introduced into the sample under magnetic stirring to analyze the zeta potential.

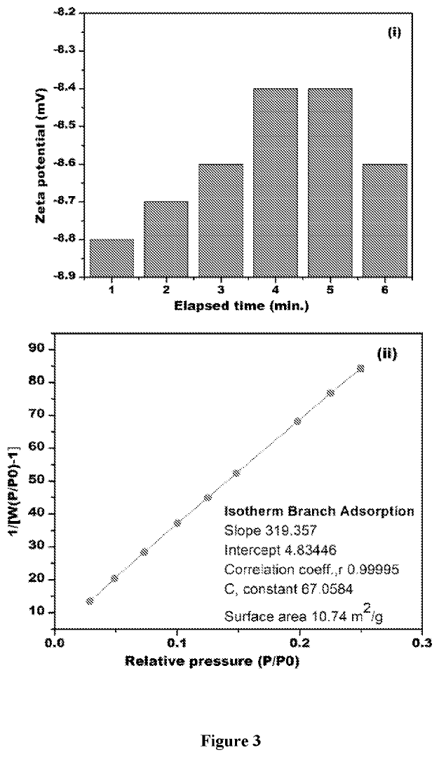

The average surface charge on R-MFC measured by the zetaprobe analyzer was-8.58 mV (the time-resolved results are shown in FIG. 3(i)). These charges were resulted from the presence of the phosphate groups (PO₄²⁻) on R-MFC. To quantitatively determine the content of phosphate groups on R-MFC, an inductive coupled mass spectroscopy (ICP-MS) analysis was also performed on dissolved R-MFC. The results indicated that the R-MFC scaffold possessed the PO₄²⁻ content of 3.89 wt %, suggesting the scaffold only had a slight degree of phosphorylation.

### Example 9

Surface Area Measurement using Brunauer-Emmett-Teller (BET) Analysis. The surface area (m²/g) of R-MFC was determined by means of N₂ adsorption using Quantachrome NOVAtouch LX2 analyzer, equipped with degasser and BET analyzer units. Before measurement, the sample was first degassed at 75° C. for 24 hours in dry N₂ gas flow. It was then inserted into a 9 mm bulb end cell and analyzed for multi-points BET adsorption-desorption isotherm in the presence of reference cell.

The specific surface area of the freeze-dried R-MFC sample was measured by the BET analysis, where its value was found to be 10.74 m²/g (FIG. 3(ii)). This value was comparatively lower than CNF samples obtained from wood, algae and bacterial cellulose using other processes. This is perhaps due to a lower degree of polymerization in R-MFC, as it was derived from the regeneration process from the dissolved jute cellulose chains after treatment with phosphoric acid, where some degree of depolymerization might have taken place.

### Example 10

Transmission Electron Microscopy (TEM). TEM of R-MFC and ZnO/R-MFC samples were recorded using a FEI Tecnai G2 Spirit BioTWIN instrument, operated at an accelerating voltage of 120 kV, and equipped with a digital camera. The instrument also possessed photographic film capability with goniometer and tilt stage accessories, as well as electron diffraction capability. Samples preparation was performed using a 10 μL aliquot sample of 0.01 wt %, deposited on freshly glow discharged carbon coated Cu grids (300 mesh, Ted Pella Inc.), followed by staining with 2 wt % aqueous uranyl acetate solution. However, no staining was applied on the ZnO/R-MFC samples.

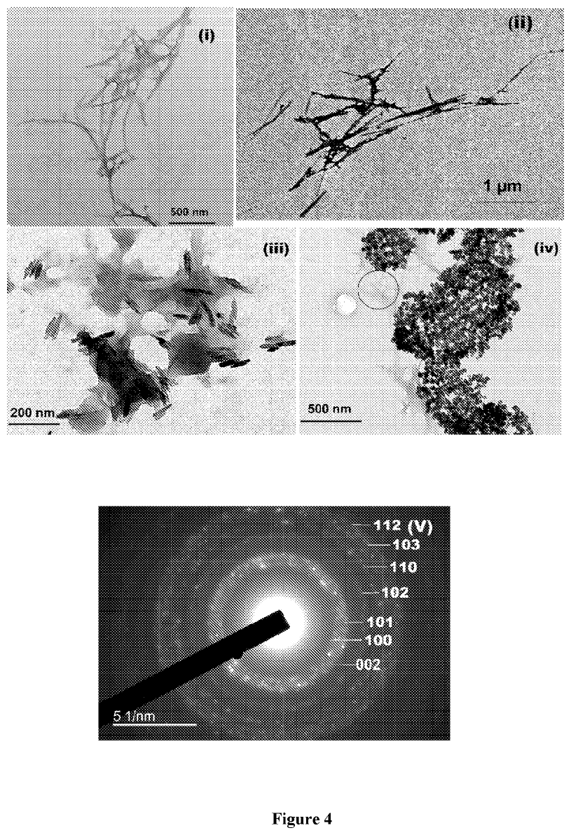

The results of the TEM imaging, demonstrating the morphology and structure of R-MFC and ZnO/R-MFC, are illustrated in FIG. 4. FIG. 4(i) exhibits the long strands of R-MFC fibers entangled at certain points. The Image J software was used to measure the average length and average width of these fibers. Based on the measurements from 20 individual fibers, the average length and width of R-MFC was 2600 and 86 nm, respectively. The overall characteristics of the R-MFC fibers prepared using the phosphoric acid treatment on jute cellulose were summarized in Table 2 below.

TABLE 2
Characteristics of R-MFC prepared using the
phosphoric acid treatment on jute cellulose.

| | | Length (L); | | | | |
|---|---|---|---|---|---|---|
| | | Diameter (D); | Zeta | Surface | PO₄²⁻ | |
| | | Aspect ratio | Potential | Area | Content | CI |
| Sample | Color | (L/D) | (mV) | (m²/g) | (%) | (%) |
| R-MFC | white | L = 2600 nm; | −8.4 | 10.74 | 3.49 | 47.5 |
| | | D = 86 nm; | | | | |
| | | L/D = 30 | | | | |

To maintain the contrast of the interactions between the electron beam and ZnO nanoparticles as well as the beam and R-MFC, the ZnO/R-MFC sample was not stained using a staining agent (e.g., uranyl acetate). The typical TEM image of ZnO/R-MFC at low magnification is shown in FIG. 4(ii). The image showed that the fibers/ZnO were integrated as dark filaments, indicating the high amount of ZnO nanocrystal coating on the R-MFC fiber.

To determine the structure of the ZnO nanocrystals, TEM images were taken from diluted suspension of ZnO nanocrystals prepared by the same procedure without the presence of R-MFC. The typical TEM image of ZnO is illustrated in FIG. 4(iii). This image indicated that ZnO nanocrystals, grown in the dilute solution without the presence of R-MFC, possessed a rod-like shape with tapered ends (average width around 7 nm and average length about 80 nm), similar to the structure observed earlier. The orientation of these nanorods was mostly parallel to the viewing plane.

However, in the presence of R-MFC (FIG. 4(iv)), some interesting features of these ZnO nanocrystals were seen.

First, the presence of R-MFC seemed to be an effective scaffold that could nucleate a large number of ZnO nanocrystals. The nucleation density of ZnO nanocrystals was very high and the formed nanocrystals were reasonably uniform.

Second, the morphology of resulting ZnO nanocrystal appeared to change from rod-like to plate-like (average diameter around 100 nm), where the hexagonal shape of plate-like nanocrystals was seen. The selected area electron diffraction (SAED) pattern of ZnO/R-MFC is shown in FIG. 4(v). The pattern showed distinct diffraction peaks aggregated into ring like features, which could be attributed to (100), (002), (101), (102), (110), (103) and (112) crystallographic planes. From this pattern, one could conclude that the ZnO nanocrystals included of the hexagonal wurtzite crystal structure, where these nanocrystals are not totally randomly placed.

### Example 11

Atomic Force Microscopy (AFM). AFM of R-MFC and ZnO/R-MFC samples was performed using a Bruker Dimension ICON scanning probe microscope (Bruker Corporation, U.S.A.) equipped with a Bruker OTESPA tip (tip radius (max.)=10 nm). In this measurement, a 10 μL of 0.005 wt % R-MFC and ZnO/R-MFC suspension was deposited on the surface of a silica plate, where the air-dried sample was measured in the tapping mode.

### Example 12

Thermogravimetric Analysis (TGA). The thermal stability of R-MFC and ZnO/R-MFC were evaluated under nitrogen flow from 30-850° C. with a heating rate of 10° C./min using a Perkin Elmer STA-6000 (Simultaneous Thermal Analyzer) instrument. The samples (~10 mg) were placed in open alumina pans in an inert atmosphere (N₂ gas flow 60 mL/min). The values of T_{onset10%} (temperature at 10% weight loss), Tₘₐₓ (temperature at maximum weight loss), and the residual at 800° C. were obtained from the measurements.

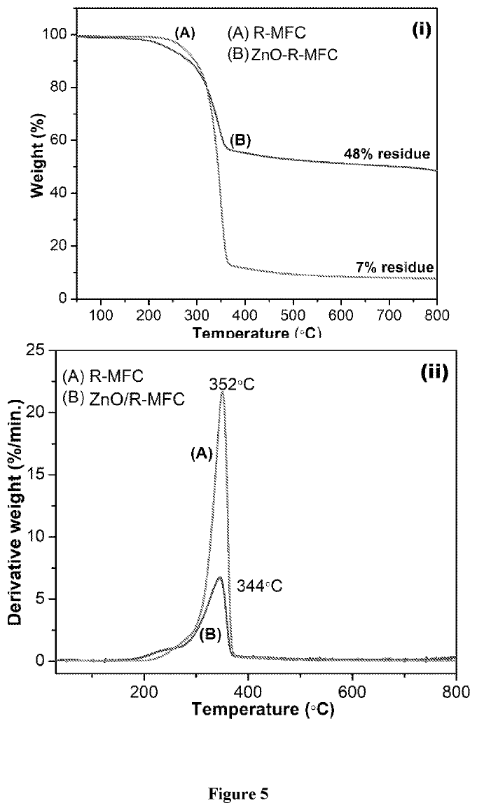

The results of the thermogravimetry analysis (TGA), demonstrating the thermal stability of R-MFC and ZnO/R-MFC, are shown in FIG. 5(i). It was seen that R-MFC exhibited the initial onset temperature (Tₒₙₛₑₜ) at 293° C. (with about 3% weight loss) and the final offset temperature (T_{offset}) at 368° C. (with about 90% weight loss). However, the thermal degradation profile of ZnO/R-MFC indicate the initial onset temperature (Tₒₙₛₑₜ) at 248° C. (with about 10% weight loss) and the final offset temperature (T_{offset}) at 360° C. (with about 42 wt % weight loss).

The shifting of the Tₒₙₛₑₜ value to a lower temperature indicated the ZnO/R-MFC had a lower thermal stability. The residual weight % left after the degradation of R-MFC at 800° C. was 7%, whereas the residual weight % left after the degradation of ZnO/R-MFC at 800° C. was 48%. This difference indicated that the loading of ZnO in the R-MFC scaffold was 41 wt %, which was in good agreement with the high amount of ZnO loading indicated in the TEM image (FIG. 4(iv)).

Differential thermogravimetry (DTG) profiles were plotted based on the TGA curves and the results are illustrated in FIG. 5(ii). The maximum degradation temperature (Tₘₐₓ) of the R-MFC was found to be 352° C., which is consistent with the results from previous studies. A slightly lower thermal decomposition temperature (344° C.) was observed for the ZnO/R-MFC. Similar results were also obtained in previous study on ZnO coated cellulose fibers.

### Example 13

Preparation of Arsenic Solution for Adsorption Study. A series of solutions having concentrations of 5, 15, 25, 50 and 100 ppm of As(V) were prepared for adsorption evaluation. For the pH effect study, a 1 ppm As(V) solution was adjusted with to form different solutions with pH values of 2, 6 and 9, respectively.

The remediation test was carried out by addition of a fixed amount (10 mg) of ZnO/R-MFC sample produced in Example 4 into a 2 mL of As(V) solution in a centrifuge tube. After the addition, the mixture was shaken manually for a few seconds and then equilibrated for 5 minutes. The white suspension containing the arsenic impurities became settled at the bottom of the centrifuge tube. The non-flocculated portion was diluted by a factor of 1000 to reach a level below 100 ppb, where the diluted suspension was then passed through a 0.1-micron filter to remove nanofibers (but not As(V) ions).

The filtrate was analyzed by ICP-MS, where the results were used to calculate the maximum removal efficiency of ZnO/R-MFC as a function of As(V) concentration. The ICP-MS data were also used to evaluate the maximum adsorption capacity using the Langmuir isotherm model, assuming monolayer adsorption on the active site of the adsorbent (ZnO/R-MFC). The Langmuir isotherm model equation is expressed in Eq. 1:

$$\frac{Ce}{Qe} = \frac{Ce}{Qm} + \frac{1}{Qmb} \qquad Eq . 1$$

where Ce is the equilibrium concentration of the adsorbate; Qe is the adsorption capacity at equilibrium; Om and b are Langmuir constants which can be calculated from the intercept and the slope of the linear plot between Ce/Qe and Ce.

### Example 14

Evaluation of As(V) Adsorption using ZnO/R-MFC. The adsorption capacity of ZnO/R-MFC for the As(V) removal was determined by the ICP-MS technique. The experimental results and the calculated ideal adsorption results for the As(V) removal (As(V) concentration range between 5-100 ppm).

The ideal adsorption capacity of ZnO/R-MFC was calculated based on the concentration of As(V) used in the solution with respect to the concentration of ZnO/R-MFC applied for the remediation test. In addition, the adsorption efficiency of ZnO/R-MFC was calculated for different As(V) concentrations. The removal efficiency of ZnO/R-MFC against 5-100 ppm of As(V) was found to be between 80-25%. This result suggests that the removal efficiency of ZnO/R-MFC decreases with the increase in As(V) ions, probably due to the reduced stability of the ZnO nanocrystals adhered in R-MFC in the presence of higher As(V) impurities.

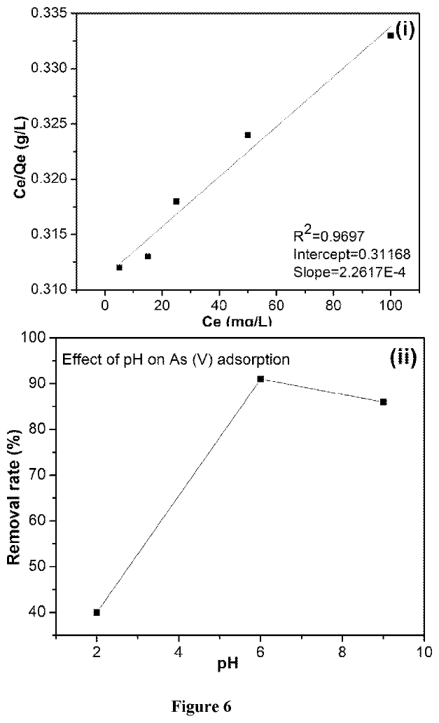

FIG. 6(i) illustrates the relationship between Ce/Qe versus Ce based on the Langmuir isotherm model. The relationship showed a decent linear relationship with the R² value of 0.829. This implies that the removal of As(V) removal by ZnO/R-MFC follows the monolayer adsorption mechanism, as assumed by the Langmuir isotherm model. Based on this analysis, the slope of the least squares regression line (LSRL) was 2.2617×10⁻⁴ in FIG. 6(i)), which was reciprocal of the adsorption capacity. Hence, the maximum adsorption capacity (Om) obtained for the ZnO/R-MFC substrate was 4,421 mg/g.

The effect of pH change on the adsorption of As(V) ions by the ZnO/R-MFC was reviewed, with the results shown in FIG. 6(ii). The results indicated that the highest efficiency occurred at the neutral condition (pH=7), which suggests the practical viability of ZnO/R-MFC. The reason for this observation (FIG. 6(ii)) is believed to be as follows. Arsenate is a weak acid and appears as H₂AsO₄⁻ in the pH range of 4-7. As a result, H₂AsO₄⁻ is very likely to be adsorbed by ZnO in this range. However, H₂AsO₄⁻ can get deprotonated and form HAsO₄²⁻ ions, which may deactivate the active site of ZnO in the ZnO/R-MFC substrate. Therefore, the ZnO/R-MFC exhibited the maximum adsorption at pH=7, which is in good agreement with the previously reported data.

The adsorption capacity of the ZnO/R-MFC scaffold for the removal of As(V) was compared with various other materials. The comparison of the As(V) adsorption capacities of different absorbents (determined from the literature) was compared with the adsorption capacity of the disclosed ZnO/R-MFC, with the results set forth in Table 3 below.

TABLE 3
Summary of the various substrates used for the As(V) removal.

| | Adsorption |
|---|---|
| Adsorbent | Capacity (mg/g) |
| ZnO/R-MFC | 4,421 |
| coconut shell carbon | 2.40 |
| coconut shell carbon pretreated with Fe(III) | 4.53 |
| coal based carbon | 4.09 |
| hyperbranched polyethyleneimine modified | 99.35 |
| cellulose fibers | |
| micro-fibrillated cellulose and Fe₂O₃ | 184.3 |
| particles | |
| cellulose loaded with iron oxyhydroxide | 33.2 |
| cellulose-iron oxide nanoparticles | 32.11 |
| polished rice | 0.15 |
| fly ash | 30 |
| egg shell membrane | 24.2 |
| granular titanium dioxide | 41.4 |
| iron doped TiO₂ | 20.4 |
| Ti-loaded basic yttrium carbonate | 38.5 |
| Fe₃O₄ nanoparticles | 16.56 |
| zirconium oxide nanoparticles | 32.4 |
| iron and aluminum oxide | 328.5 |
| magnetite reduced graphene oxide | 5.83 |

Interestingly, ZnO/R-MFC exhibited the highest adsorption capacity (4,421 mg/g) among all the adsorbents reported in the literature. It appears that there is a synergy by using the regenerated nanofibrous scaffold with cellulose II structure to anchor ZnO nanocrystals, where the resulting nanocomposite scaffold was very effective to adsorb As(V).

It has been reported that inorganic particles, such as iron oxide, titanium oxide, ferric hydroxide, zirconium oxide, either used alone or anchored in the cellulose I substrate all have shown some As(V) adsorption capacity, ranging from 4 to 38 mg/g. The highest reported As(V) adsorption capacity was 328.5 mg/g, in the composite of aluminum and iron oxide, and was lower than what was observed for ZnO/R-MFC. Also, as set forth above in Table 3, micro-fibrillated cellulose (MFC) loaded with Fe₂O₃ particles was also found to be effective for removal of As(V), but its adsorption capacity was only 184 mg/g.

### Example 15

Scanning Electron Microscopy (SEM). A Zeiss LEO 1550 SFEG-SEM instrument was used to record SEM images of ZnO/R-MFC before and after the As(V) adsorption. The instrument included an in-lens secondary electron detector in addition to the standard E-T detector, and a Rutherford backscatter electron detector. It was also equipped with an EDS (energy dispersive X-ray spectroscopy) system, providing elemental compositions and X-ray maps of the various phases of the materials examined. Images of surface morphology of ZnO/R-MFC sample were taken to observe the R-MFC surface change upon coating with ZnO nanocrystals and after the As(V) adsorption at low and high concentrations.

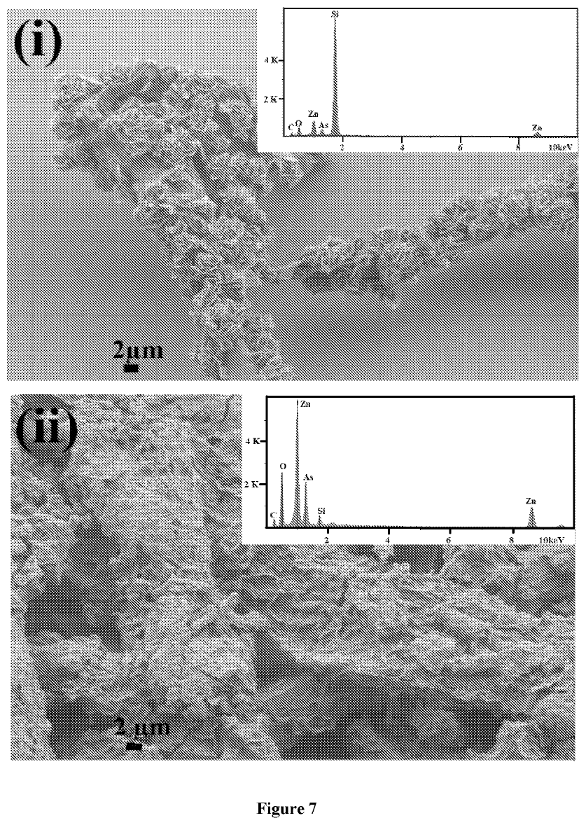

Characterization of As(V)-Adsorbed ZnO/R-MFC Floc. The combined scanning electron microscopy (SEM) and electron dispersive spectroscopy (EDS) techniques were used to characterize the morphology of As(V)-adsorbed ZnO/R-MFC system. The results are shown in FIG. 7.

SEM image of the floc obtained after adsorption of 15 ppm of As(V), illustrated the appearance of flower-like assemblies of ZnO crystals. The appearance of flower-like arrangement of ZnO is mainly caused by the nucleation and growth of ZnO nanocrystals with hexagonal wurtzite crystal structure, retained its plate-like shape (FIG. 4(iv) was obtained at lower ZnO concentration). The average width of the ZnO crystal plates in the flower-like assembly seemed to be larger than 1 μm, but the thickness was still in the nanoscale range. No visible appearance of As(V) deposition was observed in FIG. 7(i), because of the low As(V) concentration (15 ppm) used. The corresponding EDS spectrum obtained clearly showed the presence of arsenic (As), zinc (Zn), carbon (C), and oxygen (O) peaks, confirming the adsorption of the arsenic impurities by the ZnO/R-MFC scaffold.

In contrast, the SEM image of the ZnO/R-MFC floc containing high concentration (100 ppm) of As(V) impurities exhibited a completely different morphology. It was seen that the flower-like assembly of ZnO crystals, which appeared in the floc with low concentration of As(V) adsorption, totally disappeared. Instead, a thick As coating on the ZnO/R-MFC scaffold was seen.

The quantitative evidence of the presence of As(V) impurities on ZnO/R-MFC was confirmed by the corresponding EDS spectra shown in the inset of FIG. 7(ii). In identifying the EDS spectra, the appearance of the C, O and Zn peaks was due to the presence of ZnO and R-MFC scaffold, where the occurrence of the As peak was resulted from the As(V) adsorption. The intensity of the As peak in the EDS spectrum from the 100 ppm As solution was found to be much stronger than that from the 15 ppm solution, as expected.

The above results clearly indicated the mechanism of As(V) adsorption on the ZnO/R-MFC scaffold. That is the adsorption mechanism was dominated by the electrostatic interactions between ZnO and As(V) at the low As(V) concentration. However, at high concentration of As(V), the adsorption mechanism was dominated by the mineralization of As(V).

### Example 16

Adhesion Stability of ZnO Nanocrystals in ZnO/R-MFC Scaffold. The study on the bonding stability between the ZnO particles and the R-MFC scaffold was carried out by immersing 10 mg of ZnO/R-MFC composite sample separately into 10 mL of water having different pH values (i.e., 2, 7, 10) for 24 hours at room temperature. The supernatant was then analyzed by ICP-MS to determine the Zn concentration.

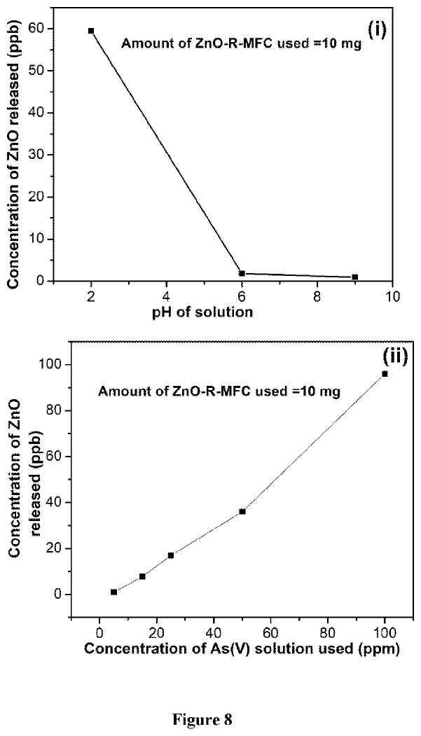

The results showed that the release of Zn ions from the ZnO/R-MFC composite was a function of the pH value. It was found that the Zn release was not significant, which was in the range of ppb amount from 10 mg of ZnO/R-MFC (containing 41 wt % Zn) in water for 24 hours. The release was found to be the largest at the pH value of 2 (i.e., 60 ppb of Zn from 10 mg of ZnO/R-MFC (containing 41 wt % Zn) as shown in FIG. 8(i)). This is most probably due to the conversion of ZnO into Zn(OH)₂, which would lead to weaker attractions between ZnO and R-MFC. The negligible release of Zn was observed with concentrations of 1.8 and 2 ppb, when the ZnO/R-MFC was immersed in the aqueous solution with pH=7 and 9, respectively, for 24 hours. The very low release of ZnO at the neutral condition (pH=7) suggests potentially practical applications.

However, the release of ZnO was found to be much higher when the water contained As(V) ions. The results from the study of ZnO released from ZnO/R-MFC as a function of As(V) concentration are shown in FIG. 8(ii), which showed that the ZnO release (in ppb) drastically elevated when the As(V) concentration (in ppm) increased. To be specific, the ZnO release increased from 0.96 to 100 ppb, when the As(V) concentration increased from 5 to 100 ppm. This behavior might be attributed to the decreasing electrostatic attractions between ZnO nanocrystals and R-MFC, when the concentration of competing As(V) ions increased.

### DISCUSSION

As noted above in the Examples, wet cellulose fibers extracted from raw jute biomass were used to generate R-MFC. Due to the lack of porosity, dry fibers were less accessible to chemical reaction as compared to wet fibers. The presence of moisture in the fibers was found to have a significant effect on the generation of R-MFC. In specific, fibers with moisture content of 20-25% were observed to lead to easy dissolution in phosphoric acid. However, higher moisture content of 30-35% was observed to result in unsuccessful dissolution of these fibers in phosphoric acid. This is because the presence of a large amount of water molecules around the fibers prevented direct interactions of acid molecules with cellulose.

A recent study on the nanotoxicology of ZnO nanoparticles using Sprague Dawley rats indicated that these nanoparticles are non-toxic below the concentration of 125 mg/kg. Hence, the potential ZnO release from the nanocomposite scaffold of the present disclosure in any practical applications should be much lower than the reported safety level. In other words, the system of ZnO/R-MFC may be more appropriate for practical applications when compared to other systems containing zirconium oxide nanoparticles, titanium dioxide nanoparticles, yttrium nanoparticles, iron and carbon nanotubes composites, which would incur a much higher risk of toxicity.

To summarize, a unique nanocomposite scaffold, containing ZnO nanocrystals adhered in a regenerated micro-fibrillated cellulose (R-MFC) substrate, was demonstrated. The cellulose II structure of R-MFC appeared to be very effective to anchor the ZnO nanocrystals, where the adhesion appeared to be due to strong electrostatic interactions based on FTIR, WAXD and binding stability experiments.

The ZnO/R-MFC system was an effective adsorption system to remove As(V) ions from water, where the maximum adsorption capacity of the system is 4,421 mg/g based on the Langmuir isotherm model. The ZnO nanocrystals formed in the low Zn concentration appeared to be consistent with the plate-like morphology with the hexagonal wurtzite crystal structure, where the plate also exhibited a hexagonal shape. SEM examination of the ZnO nanocrystals formed under higher concentration indicated that ZnO crystals grew along the in-plane direction and formed a flower-like morphology in the R-MFC scaffold. These ZnO crystallites were effective adsorption medium for removal of As(V) ions from water, where the best removal efficiency is at the neutral condition (pH=7).

In addition, excellent binding stability between ZnO nanocrystals and the R-MFC scaffold was found, where very low release of ZnO (ppb) took place during the As(V) adsorption.

While the invention has been shown and described with reference to certain embodiments of the present invention thereof, it will be understood by those skilled in the art that various changes in from and details may be made therein without departing from the spirit and scope of the present invention and equivalents thereof.

What is claimed is:

1. A nanocomposite scaffold comprising:
a cellulose substrate; and
metal oxide nanocrystals selected from zinc oxide, iron(II) oxide, iron(III) oxide, titanium dioxide, aluminium oxide, copper(II) oxide, copper(I) oxide, calcium oxide, lithium oxide, silver oxide, manganese dioxide, manganese(II) oxide, sodium oxide, magnesium oxide, chromium(VI) oxide, or combinations thereof,
wherein the metal oxide nanocrystals are present in an amount from about 20% by weight of the nanocomposite scaffold to about 50% by weight of the nanocomposite scaffold.

2. The nanocomposite scaffold of claim 1, wherein the metal oxide nanocrystals are present in an amount from about 30% by weight of the nanocomposite scaffold to about 45% by weight of the nanocomposite scaffold.

3. The nanocomposite scaffold of claim 1, wherein the cellulose substrate is formed of regenerated microfibrillated cellulose, nanofibrillated cellulose, cellulose nanocrystals, cellulose nanofibers, or combinations thereof.

4. The nanocomposite scaffold of claim 3, wherein the cellulose substrate is formed of regenerated microfibrillated cellulose fibers having a length from about 200 nm to about 300 nm and a diameter from about 100 nm to about 200 nm.

5. The nanocomposite scaffold of claim 3, wherein the cellulose substrate is formed of regenerated microfibrillated cellulose fibers having a length from about 225 nm to about 275 nm and a diameter from about 125 nm to about 175 nm.

6. The nanocomposite scaffold of claim 4, wherein the regenerated microfibrillated cellulose includes a cellulose II polymorph.

7. The nanocomposite scaffold of claim 4, wherein the metal oxide nanocrystals include zinc oxide.

8. A method comprising:
contacting cellulose fibers with an acid selected from phosphoric acid, sulfuric acid, hydrochloric acid nitric acid, or combinations thereof, the acid at a concentration from about 70% by weight to about 90% by weight, for a period of time from about 2.5 minutes to about 7.5 minutes, to form a suspension;
heating the suspension to a temperature from about 65° C. to about 75° C., for a period of time from about 25 minutes to about 35 minutes, to form a solution;
contacting the solution with ethanol, butyl carbitol, butyl cellusolve, diethylene glycol monobutyl ethers, or diethylene glycol monoethyl ethers,
cooling the solution;
removing the supernatant; and
collecting regenerated microfibrillated cellulose fibers.

9. The method of claim 8, wherein the cellulose fibers are jute fibers having a moisture content from about 17.5% by weight to about 27.5% by weight.

10. The method of claim 8, wherein contacting the cellulose fibers with the acid occurs by contacting the cellulose fibers with the acid at a concentration from about 80% by weight to about 87.5% by weight.

11. The method of claim 8, wherein contacting the cellulose fibers with the acid occurs at a temperature from about 65° C. to about 90° C., for a period of time from about 25 minutes to about 35 minutes.

12. The method of claim 8, further comprising contacting the regenerated microfibrillated cellulose fibers with metal oxide nanocrystals selected from zinc oxide, iron(II) oxide, iron(III) oxide, titanium dioxide, aluminium oxide, copper(II) oxide (CuO), copper(I) oxide, calcium oxide, lithium oxide, silver oxide, manganese dioxide, manganese(II) oxide, sodium oxide, magnesium oxide, chromium(VI) oxide, or combinations thereof, to form a nanocomposite scaffold including a cellulose substrate and the metal oxide nanocrystals.

13. The method of claim 8, further comprising contacting a solution possessing metal oxide nanocrystals or precursors thereof with a first suspension including the regenerated microfibrillated cellulose fibers, to form a nanocomposite scaffold including a cellulose substrate and the metal oxide nanocrystals.

14. The method of claim 13, wherein the metal oxide nanocrystals are selected from zinc oxide, iron(II) oxide, iron(III) oxide, titanium dioxide, aluminium oxide, copper(II) oxide, copper(I) oxide, calcium oxide, lithium oxide, silver oxide, manganese dioxide, manganese(II) oxide, sodium oxide, magnesium oxide, chromium(VI) oxide, or combinations thereof.

15. The method of claim 13, wherein the solution possessing metal oxide nanocrystals and the first suspension including the regenerated microfibrillated cellulose fibers are combined to form a second suspension.

16. The method of claim 15, wherein the second suspension is heated to a temperature from about 70° C. to about 90° C. and adjusted to a pH value of from about 8 to about 12.

17. The method of claim 16, further comprising heating the second suspension for a period of time from about 1 hour to about 3 hours.

18. The method of claim 16, further comprising removing the supernatant from the second suspension to obtain a nanofibrous composite scaffold formed of a cellulose substrate and metal oxide nanocrystals.

19. The method of claim 16, further comprising drying the nanocomposite scaffold at a temperature from about 95° C. to about 105° C.

20. A method for purifying water, comprising contacting the water with the nanocomposite scaffold of claim 1.
